(19) United States
(12) Patent Application Publication
(10) Pub. No.: US 2009/0327872 A1
(43) Pub. Date: Dec. 31, 2009

(54) OBJECT EDITING INCLUDING LAYOUT MODES DURING DRAG AND DROP OPERATIONS

(75) Inventors: Yoshiroh Kamiyama, Tokyo (JP); Keiji Miura, Yamato-Shi (JP); Kotaro Shima, Tokyo (JP)

Correspondence Address: CANTOR COLBURN LLP - IBM LOTUS, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/147,639

(22) Filed: Jun. 27, 2008

(51) Int. Cl. G06F 3/048; G06F 17/00

(52) U.S. Cl. 715/243; 715/769

(57) ABSTRACT

Systems, methods and computer products for object editing including specification of layout modes during drag and drop operations. Exemplary embodiments include, a method for object editing including specification of layout modes during electronic editing of a document on the display, the method including retrieving a plurality of objects, displaying the objects on a display of a computer, receiving an object selection signal indicative of a selection device pointing at a selected object from the plurality of objects, in response to the object selection signal, dragging a representation of the object to a destination location on the display, receiving a pause selection signal indicative of the selection device pausing during the dragging of the presentation of the object, in response to the pause selection signal, retrieving a mode change switch from the memory, displaying the mode-change switch on the display and dropping the object at the destination location.

### BACKGROUND

The present disclosure relates generally to electronic document editing and, in particular, to systems, methods and computer products for object editing including specification of layout modes during drag and drop operations.

In editing a document in a word processor or in an HTML editor, multiple different layout modes are generally used within a document. Typically, there are two layout modes: flow layout; and “free layout”. Flow layout is implemented to locate contents in order from left to right and top to bottom. Free layout is implemented to locate contents in the absolute coordinate. Common word processors and HTML editors are equipped with the function to move objects, such as text, images, buttons, and other objects involved with editing. This function allows simple drag-and-drop operations. However, the function is limited to use within the same layout mode only. For example, it is impossible to move an image arranged with the free layout mode to a table cell with the flow layout mode by a drag-and-drop operation. Currently in order to move an object arranged with the free layout mode to a table cell with the flow layout mode by a drag-and-drop operation, it is generally necessary to first change the property of the layout mode for the object to be moved.

### BRIEF SUMMARY

Exemplary embodiments include, in a computer system, a method for object editing including specification of layout modes during electronic editing of a document on the display, the method including retrieving a plurality of objects displaying the objects on a display of a computer, receiving an object selection signal indicative of a selection device pointing at a selected object from the plurality of objects, in response to the object selection signal, dragging a representation of the object to a destination location on the display, receiving a pause selection signal indicative of the selection device pausing during the dragging of the presentation of the object, in response to the pause selection signal, retrieving a mode change switch from the memory, displaying the mode-change switch on the display and dropping the object at the destination location.

Additional exemplary embodiments include a method for object editing including specification of layout modes during electronic editing of a document, the method including identifying an object to drag from a start location to a destination location in the document, selecting the object, dragging the object toward the destination location, pausing the dragging of the object, determining a display mode from a mode-change tool displayed adjacent to a frame associated with the object, continuing the dragging of the object to the destination location and dropping the object at the destination location.

Further exemplary embodiments include a computer program product for object editing including specification of layout modes during electronic editing of a document, the computer program product including instructions for causing a computer to implement a method, the method including retrieving a plurality of objects, displaying the objects on a display of a computer, receiving an object selection signal indicative of a selection device pointing at a selected object from the plurality of objects, in response to the object selection signal, dragging a representation of the object to a destination location on the display, receiving a pause selection signal indicative of the selection device pausing during the dragging of the presentation of the object, in response to the pause selection signal, retrieving a mode change switch from the memory, displaying the mode-change switch on the display and dropping the object at the destination location.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE SEVERAL VIEWS OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIGS. 1-3 illustrate examples of the layout mode selection screens in common word processors and HTML editors.

FIG. 4 illustrates a flow chart of a method for moving objects in a document along with a specification of the layout mode in the document in accordance with exemplary embodiments;

FIG. 5. illustrates a diagram of a state where an object is overlapped on a container object in accordance with exemplary embodiments;

FIG. 6 illustrates a parent-child relationship among objects in accordance with exemplary embodiments;

FIG. 7 illustrates a sibling relationship among objects in accordance with exemplary embodiments;

FIGS. 8A-8F illustrate examples of dragging and dropping operations in accordance with exemplary embodiments; and

FIG. 9 illustrates an exemplary embodiment of a system for moving objects in a document along with a specification of the layout mode in the document.

The detailed description explains the preferred embodiments of the invention, together with advantages and features, by way of example with reference to the drawings.

### DETAILED DESCRIPTION

In exemplary embodiments, the systems and methods described herein provide the ability to move objects in a document along with a specification of the layout mode in the document. As such, while editing a document a user can freely move objects with drag and drop operations that include the layout mode in the drag and drop operations.

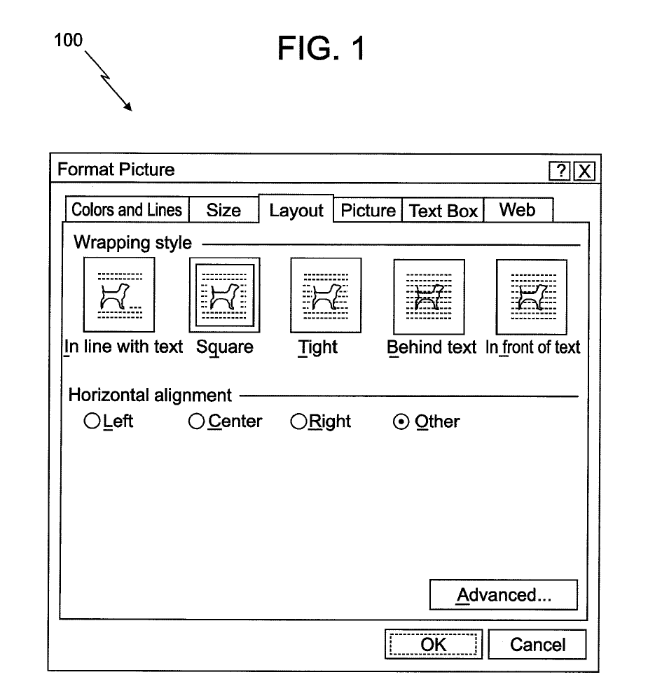

FIGS. 1-3 illustrate examples of the layout mode selection screens in common word processors and HTML editors. In exemplary embodiments, the systems and methods described herein can be implemented in many editors to provide layout mode changes as desired in a particular application for a particular image.

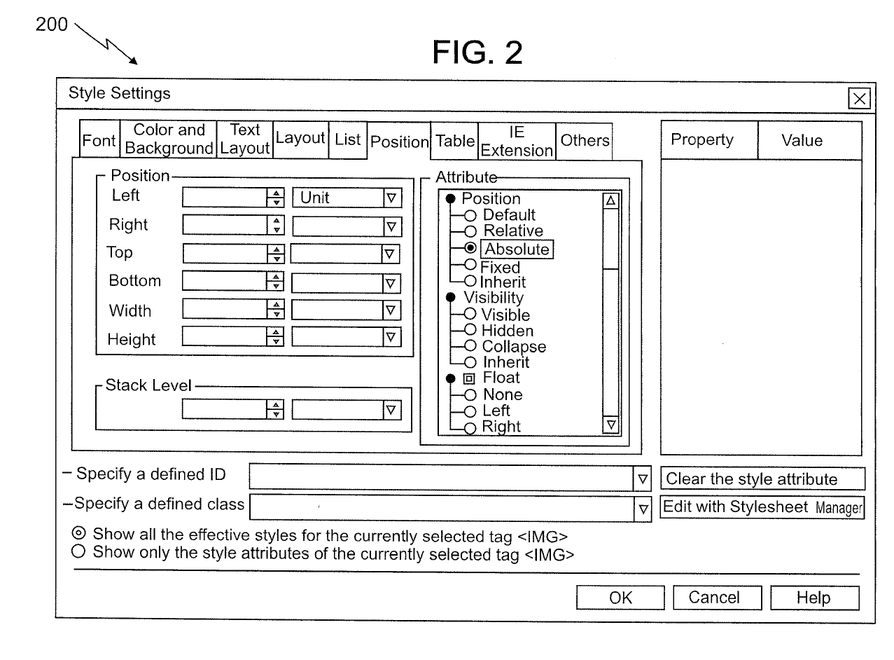

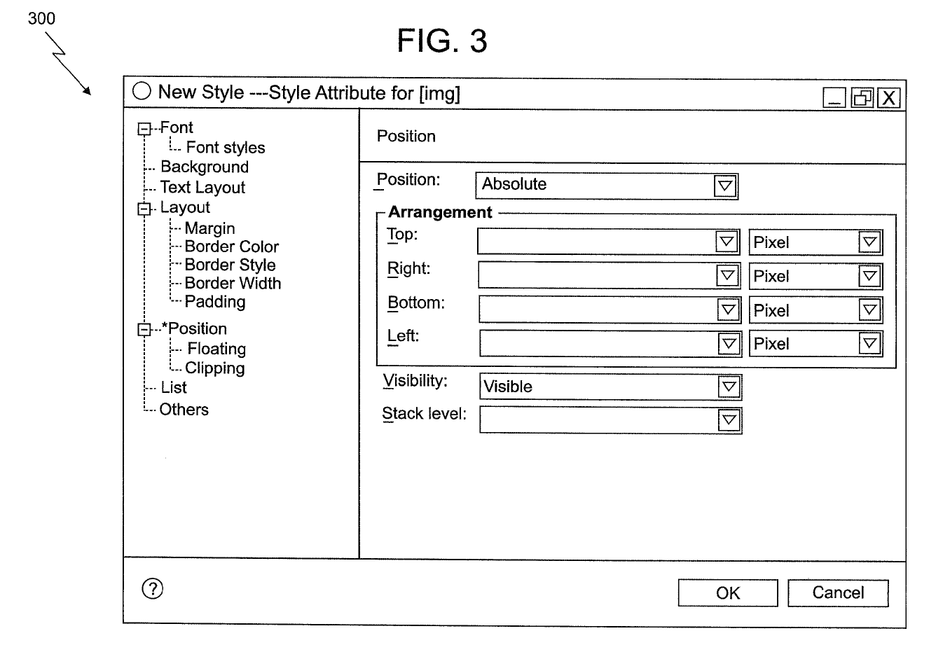

FIG. 1 illustrates a screenshot 100 of a change of layout mode in Microsoft® Word®. FIG. 2 illustrates a screenshot 200 of a change of layout mode in HomePage Builder®. FIG. 3 illustrates a screenshot 300 of a change of layout mode in Rational Application Developer Page Designer.

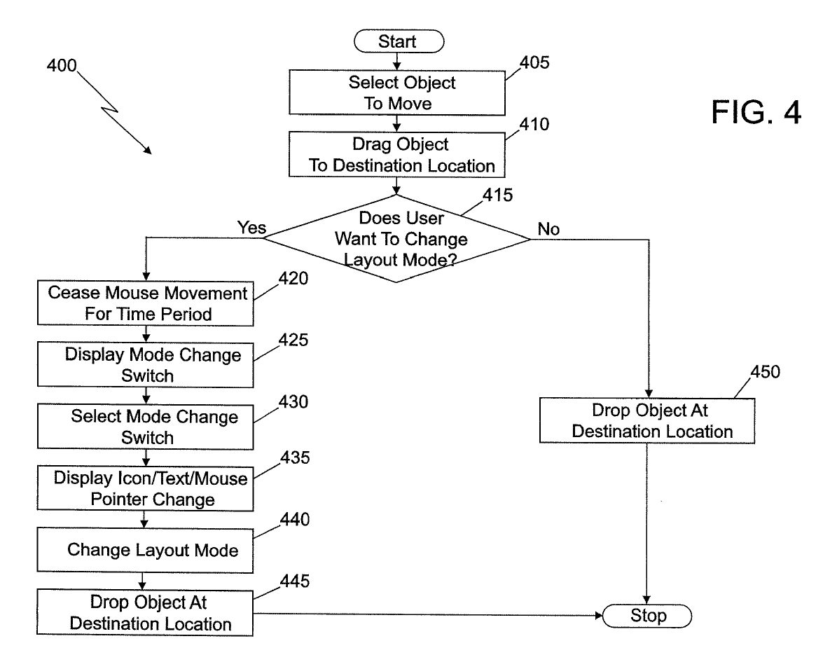

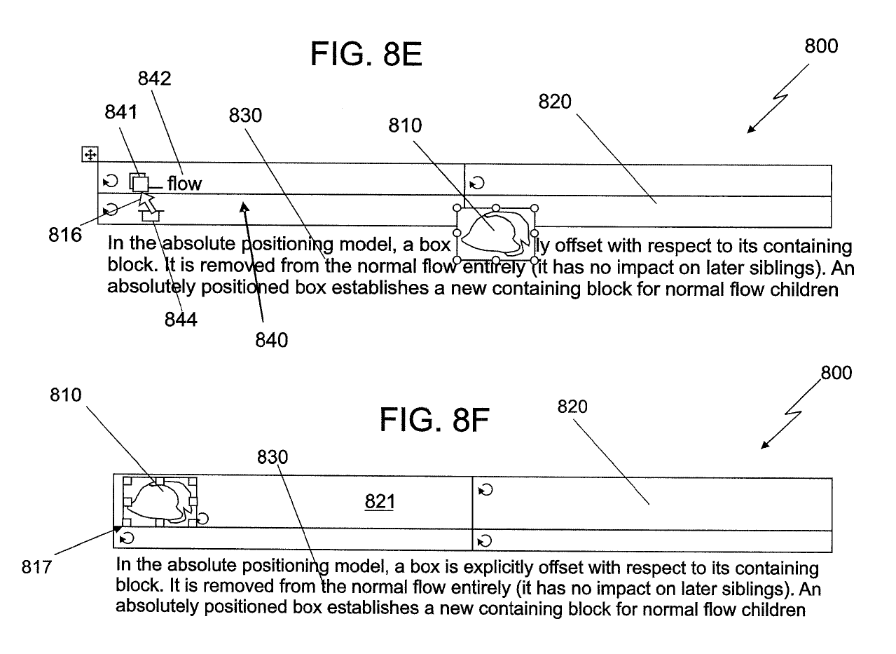

FIG. 4 illustrates a flow chart of a method 400 for moving objects in a document along with a specification of the layout mode in the document in accordance with exemplary embodiments. At block 405, the user selects an object to move to a destination location on the document. At block 410, the user can drag the object to be moved with the mouse. It is appreciated that, generally, only the frame indicating the outline of the object is dragged and the object itself still remains in the original position (see FIGS. 8A-8F). At block 415, the method 400 can determine whether the user wants to change the layout mode. If the layout mode is not to be changed, then the object can be dropped at the destination location at block 450. In an exemplary embodiment, if the layout mode is to be changed at block 415, the user can stop the mouse pointer temporarily for a determined time during dragging at block 420. In exemplary embodiments, a mode change switch (e.g., an icon, and text indicating current layout mode) is displayed close to the mouse pointer at block 425. The user can then overlap the mouse pointer on the icon or text to change the layout mode at block 430. In exemplary embodiments, a change of the layout mode can be recognized by the indication of the icon, text (i.e., indicating current layout mode), and/or shape of the mouse pointer at block 435. The user can then select the new mode at block 440. Then, while keeping the present indication state, by dropping the object in the destination location, the object is inserted in the destination location with the changed layout mode at block 445. Therefore, moving an object along with specifying the layout mode in one drop-and-drag operation by using the mouse is realized.

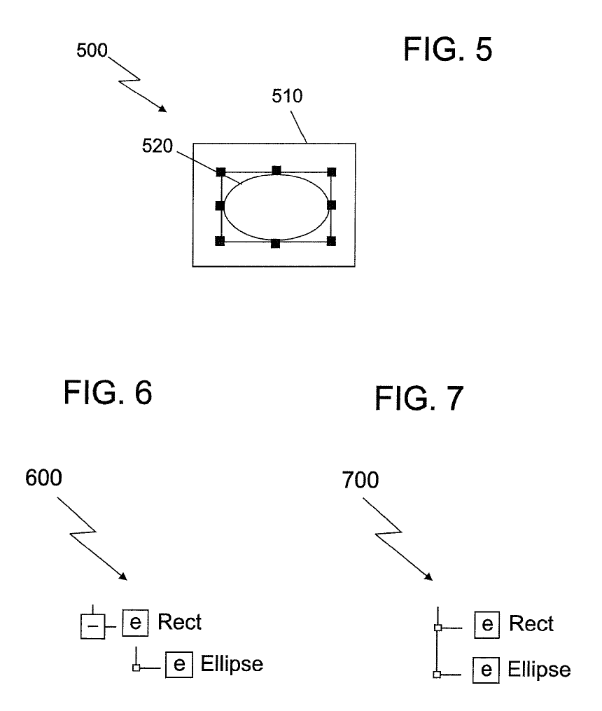

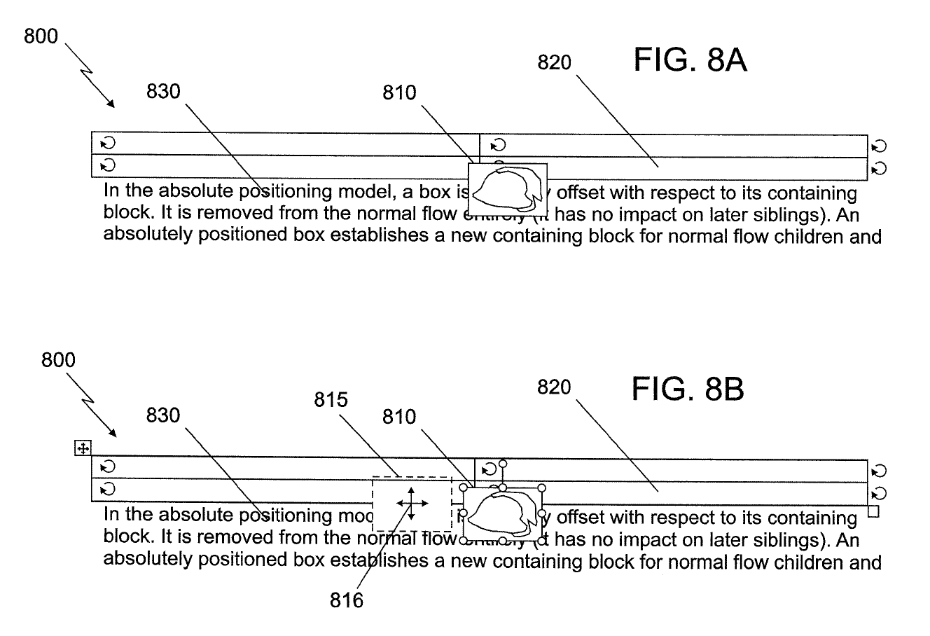

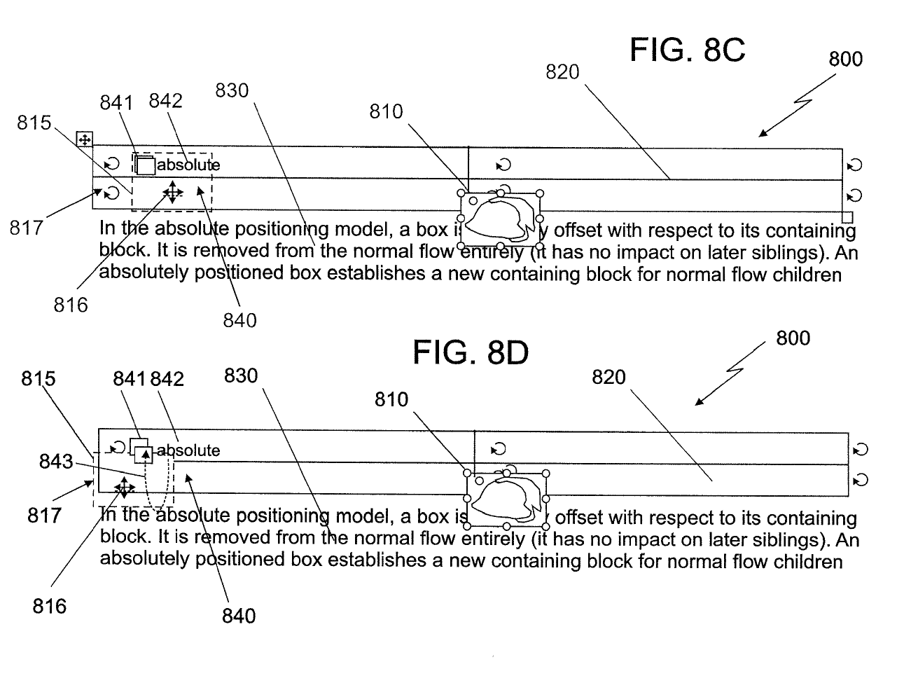

In exemplary embodiments, the systems and methods described herein can be applied not only to operations of moving objects which are already added to and located in a document, but also to other operations including addition of a new object from a palette by drag-and-drop operation. Furthermore, the systems and methods described herein can be implemented as a way to change other types of modes when moving/adding objects, in addition to changing the layout mode from/to “flow layout”/“free layout”. For example, the systems and methods described herein can be implemented in moving an object 520 onto a container object 510 (See FIG. 5), to specify if the movement is to be executed as adding a child object to the container (See FIG. 6), or as a mere moving to an overlapping position without having a parent-child relationship with the container (See FIG. 7). FIG. 5 illustrates a state where another object (i.e., an ellipse) is dragged to a position that overlaps to a container object 510 (i.e., a rectangle). If the mouse cursor is paused at that position for a short period of time (e.g. one second), a mode switch, whose icon/labels indicate the current dropping mode is “add as a child of a container”, is displayed near the cursor. If the user chooses to drop the ellipse object in the current mode (“add as a child of a container” mode), the ellipse (the object 520) is added as a child of the rectangle container object. FIG. 6 illustrates the resulting object tree structure, a parent-child relationship in accordance with exemplary embodiments. Alternatively, the user may choose to switch to “move as a top level node” mode. If the mouse cursor is hovered over the mode switch, the icon as well as label of the mode switch changes to indicate that the current dropping mode has changed to “move as a top level node” mode. Dropping the ellipse object in the “move as a top level node” mode simply moves the object to that position without changing parent. FIG. 7 illustrates the resulting object tree structure, a sibling relationship in accordance with exemplary embodiments.

FIGS. 8A-8F illustrate examples of the exemplary layout mode specification methods as described herein. In FIG. 8A an image 810 is located with a free layout mode (e.g., in an absolute coordinate) on a table 820 and text 830 with the flow layout mode. In an exemplary embodiment, as a user starts dragging the image 810 by using the mouse, the frame 815 indicating the outline of the image 810 moves, which is current behavior of the frame 815 FIG. 8B illustrates an example of the frame 815 moving via a mouse pointer 816 as the user selects and drags the image 810.

FIG. 8C illustrates the frame 815 at a destination location 817. In exemplary embodiments, when the user temporarily stops the mouse pointer 816 for a short time period (e.g. for one second) at the destination location 817, a mode change switch 840 (having an icon 841 and text 842 indicating the current mode) is displayed in close to the mouse pointer 816. In exemplary embodiments, by moving the mouse pointer 816 in the path shown in arrow 843 so that it moves over the mode-change switch 840, the layout mode in the mode-change switch 840 is changed. In this example, the layout mode is changed to the flow layout as indicated in FIG. 8E. A change of the layout mode can be recognized by the indication of the icon 841 on the mode-change switch 840, text 842 (i.e., indicating current mode) on the mode-change switch 840, and/or shape of the mouse pointer 816. It is appreciated that the layout mode change can be indicated by other indications in alternate exemplary embodiments. In addition, the effect of placing the mouse pointer on the mode change switch 840 can be defined as returning to the previous mode (toggle) or further changing to another mode, which is indicated by icon and label of mode switch 840. As such, by placing the mouse pointer 816 on the mode change switch 840, the user can toggle between different layouts via the toggle icon 844. Finally, as the mouse pointer 816 is dropped while in the flow layout mode, in this example, the image 810 is inserted in a cell 821 (e.g., the destination location 817) of the table 820 as illustrated in FIG. 8F.

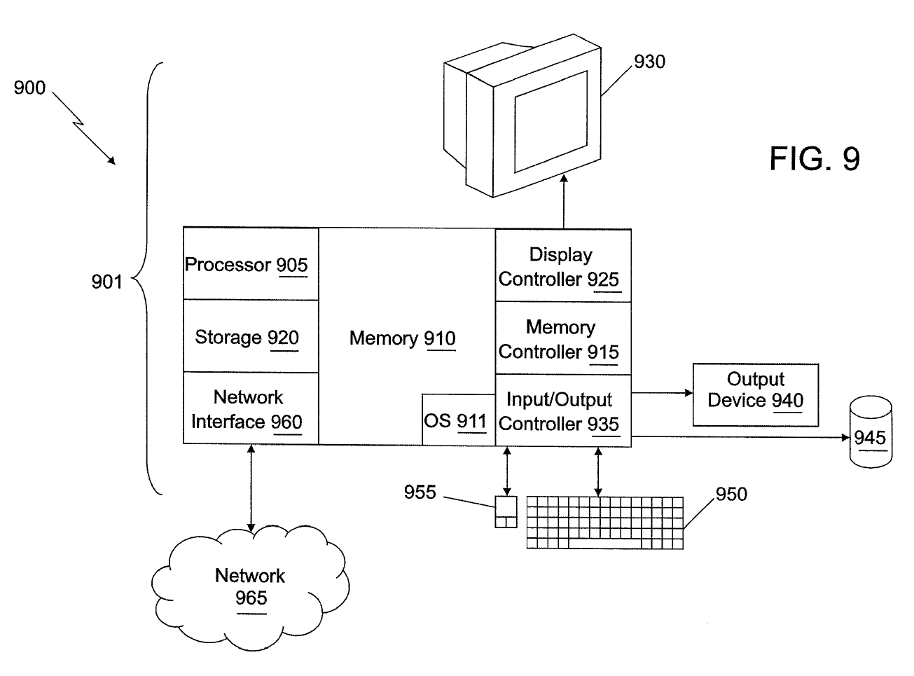

FIG. 9 illustrates an exemplary embodiment of a system 900 for moving objects in a document along with a specification of the layout mode in the document. The methods described herein can be implemented in software (e.g., firmware), hardware, or a combination thereof. In exemplary embodiments, the methods described herein are implemented in software, as an executable program, and is executed by a special or general-purpose digital computer, such as a personal computer, workstation, minicomputer, or mainframe computer. The system 900 therefore includes general-purpose computer 901.

In exemplary embodiments, in terms of hardware architecture, as shown in FIG. 1, the computer 901 includes a processor 901, memory 910 coupled to a memory controller 915, and one or more input and/or output (I/O) devices 940, 945 (or peripherals) that are communicatively coupled via a local input/output controller 935. The input/output controller 935 can be, for example but not limited to, one or more buses or other wired or wireless connections, as is known in the art. The input/output controller 935 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 905 is a hardware device for executing software, particularly that stored in memory 910. The processor 905 can be any custom made or commercially available processor, a central processing unit (CPU), an auxiliary processor among several processors associated with the computer 901, a semiconductor based microprocessor (in the form of a microchip or chip set), a macroprocessor, or generally any device for executing software instructions.

The memory 910 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 910 may incorporate electronic, magnetic, optical, and/or other types of storage media. Note that the memory 910 can have a distributed architecture, where various components are situated remote from one another, but can be accessed by the processor 905.

The software in memory 910 may include one or more separate programs, each of which includes an ordered listing of executable instructions for implementing logical functions. In the example of FIG. 1, the software in the memory 910 includes the layout mode specification methods described herein in accordance with exemplary embodiments and a suitable operating system (OS) 911. The operating system 911 essentially controls the execution of other computer programs, such as the layout mode specification systems and methods described herein, and provides scheduling, input-output control, file and data management, memory management, and communication control and related services.

The layout mode specification methods described herein may be in the form of a source program, executable program (object code), script, or any other entity comprising a set of instructions to be performed. When a source program, then the program needs to be translated via a compiler, assembler, interpreter, or the like, which may or may not be included within the memory 910, so as to operate properly in connection with the OS 911. Furthermore, the layout mode specification methods can be written as an object oriented programming language, which has classes of data and methods, or a procedure programming language, which has routines, subroutines, and/or functions.

In exemplary embodiments, a conventional keyboard 950 and mouse 955 can be coupled to the input/output controller 935. Other output devices such as the I/O devices 940, 945 may include input devices, for example but not limited to a printer, a scanner, microphone, and the like. Finally, the I/O devices 940, 945 may further include devices that communicate both inputs and outputs, for instance but not limited to, a NIC or modulator/demodulator (for accessing other files, devices, systems, or a network), a radio frequency (RF) or other transceiver, a telephonic interface, a bridge, a router, and the like. The system 900 can further include a display controller 925 coupled to a display 930. In exemplary embodiments, the system 900 can further include a network interface 960 for coupling to a network 965. The network 965 can be an IP-based network for communication between the computer 901 and any external server, client and the like via a broadband connection. The network 965 transmits and receives data between the computer 901 and external systems. In exemplary embodiments, network 965 can be a managed IP network administered by a service provider. The network 965 may be implemented in a wireless fashion, e.g., using wireless protocols and technologies, such as WiFi, WiMax, etc. The network 965 can also be a packet-switched network such as a local area network, wide area network, metropolitan area network, Internet network, or other similar type of network environment. The network 965 may be a fixed wireless network, a wireless local area network (LAN), a wireless wide area network (WAN) a personal area network (PAN), a virtual private network (VPN), intranet or other suitable network system and includes equipment for receiving and transmitting signals.

If the computer 901 is a PC, workstation, intelligent device or the like, the software in the memory 910 may further include a basic input output system (BIOS) (omitted for simplicity). The BIOS is a set of essential software routines that initialize and test hardware at startup, start the OS 911, and support the transfer of data among the hardware devices. The BIOS is stored in ROM so that the BIOS can be executed when the computer 901 is activated.

When the computer 901 is in operation, the processor 905 is configured to execute software stored within the memory 910, to communicate data to and from the memory 910, and to generally control operations of the computer 901 pursuant to the software. The layout mode specification methods described herein and the OS 22, in whole or in part, but typically the latter, are read by the processor 905, perhaps buffered within the processor 905, and then executed.

When the systems and methods described herein are implemented in software, as is shown in FIG. 9, it the methods can be stored on any computer readable medium, such as storage 920, for use by or in connection with any computer related system or method. In the context of this document, a computer readable medium is an electronic, magnetic, optical, or other physical device or means that can contain or store a computer program for use by or in connection with a computer related system or method. The layout mode specification methods described herein can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In exemplary embodiments, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In exemplary embodiments, where the layout mode specification methods are implemented in hardware, the layout mode specification methods described herein can implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

In exemplary embodiments, one or more processes in the memory 910 can monitor activity from the keyboard 950 and the mouse 955 or a combination thereof. The processes can further monitor long-running jobs that have been initiated on the computer 901. The processes can further monitor which and how many other machines can control the computer 901 either locally or remotely. In exemplary embodiments, the processes can also inquire or accept a grace period input by a user of the computer 901. The grace period can be a time period after which all traffic to and from the computer ceases if no further activity has been sensed by the processes. In this way, if a user has left the computer 901 for an extended period of time or has left the computer (e.g., after a work day) the computer 901 no longer allows traffic to and from the computer 901. In an alternative implementation, the computer 901 can totally power down after the grace period has expired. In further exemplary embodiments, the processes can accept traffic only from a common network maintenance control system that provides limited services.

As described above, embodiments can be embodied in the form of computer-implemented processes and apparatuses for practicing those processes. In exemplary embodiments, the invention is embodied in computer program code executed by one or more network elements. Embodiments include computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Embodiments include computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

1. In a computer system having a graphical user interface including a display, a memory and a selection device, a method for object editing including specification of layout modes during electronic editing of a document on the display, the method comprising:
retrieving a plurality of objects;
displaying the objects on the display;
receiving an object selection signal indicative of the selection device pointing at a selected object from the plurality of objects;
in response to the object selection signal, dragging a representation of the object to a destination location on the display;
receiving a pause selection signal indicative of the selection device pausing during the dragging of the presentation of the object;
in response to the pause selection signal, retrieving a mode change switch from the memory;
displaying the mode-change switch on the display; and
dropping the object at the destination location.

2. The method as claimed in claim 1 wherein the representation of the object is a frame indicating the outline of the object.

3. The method as claimed in claim 1 wherein the mode-change switch comprises an icon and text.

4. The method as claimed in claim 1 further comprising:
receiving a mode-change selection signal indicative of the selection device placed adjacent the mode-change switch; and
in response to the mode-change selection signal, changing a layout mode of the object.

5. The method as claimed in claim 4 wherein a change of the layout mode includes a change in the mode-change switch.

6. The method as claimed in claim 5 wherein the change of the layout mode includes at least one of a change in an icon associated with the mode-change switch, text associated with the mode-change switch and a shape of a pointer associated with a location of the selection device on the display.

7. The method as claimed in claim 1 further comprising:
receiving a mode-change selection signal indicative of the selection device pointing at the mode-change tool; and
in response to the mode-change selection signal, changing a layout mode of the object.

8. The method as claimed in claim 7 further comprising:
receiving a toggle selection signal indicative of the selection device pointing at the mode-change switch;
in response to the toggle selection signal, changing between layout modes associated with the object.

9. A method for object editing including specification of layout modes during electronic editing of a document, the method comprising:
identifying an object to drag from a start location to a destination location in the document;
selecting the object;
dragging the object toward the destination location;
pausing the dragging of the object;
determining a display mode from a mode-change tool displayed adjacent to a frame associated with the object;
continuing the dragging of the object to the destination location; and
dropping the object at the destination location.

10. The method as claimed in claim 9 further comprising selecting a change to the display mode for the object.

11. The method as claimed in claim 10 wherein selecting a change to the display mode for the object comprises selecting a new display mode for the object from the mode-change tool from a current display mode of the object.

12. The method as claimed in claim 11 further comprising toggling among different display modes associated with the object.

13. A computer program product for object editing including specification of layout modes during electronic editing of a document, the computer program product including instructions for causing a computer to implement a method, the method comprising:
retrieving a plurality of objects;
displaying the objects on a display of a computer;
receiving an object selection signal indicative of a selection device pointing at a selected object from the plurality of objects;
in response to the object selection signal, dragging a representation of the object to a destination location on the display;
receiving a pause selection signal indicative of the selection device pausing during the dragging of the presentation of the object;
in response to the pause selection signal, retrieving a mode change switch from the memory;
displaying the mode-change switch on the display; and
dropping the object at the destination location.

14. The computer program product as claimed in claim 13 wherein the representation of the object is a frame indicating the outline of the object.

15. The method as claimed in claim 13 wherein the mode-change switch comprises an icon and text.

16. The computer program product as claimed in claim 13 wherein the method further comprises:
receiving a mode-change selection signal indicative of the selection device placed adjacent at the mode-change switch; and
in response to the mode-change selection signal, changing a layout mode of the object.

17. The computer program product as claimed in claim 16 wherein a change of the layout mode includes a change in the mode-change switch.

18. The computer program product as claimed in claim 17 wherein the change of the layout mode includes at least one of a change in an icon associated with the mode-change switch, text associated with the mode-change switch and a shape of a pointer associated with a location of the selection device on the display.

19. The computer program product as claimed in claim 13 wherein the method further comprises:
receiving a mode-change selection signal indicative of the selection device pointing at the mode-change tool; and
in response to the mode-change selection signal, changing a layout mode of the object.

20. The computer program product as claimed in claim 19 wherein the method further comprises:
receiving a toggle selection signal indicative of the selection device pointing at the mode-change switch;
in response to the toggle selection signal, changing between layout modes associated with the object.
